(19) United States
(12) Patent Application Publication
(10) Pub. No.: US 2024/0162480 A1
(43) Pub. Date: May 16, 2024

(54) SOLID ELECTROLYTE MATERIAL AND ALL-SOLID-STATE BATTERY

(71) Applicant: TDK CORPORATION, Tokyo (JP)

(72) Inventors: Haruna KATO, Tokyo (JP); Hisashi SUZUKI, Tokyo (JP); Tetsuya UENO, Tokyo (JP); Chieko SHIMIZU, Tokyo (JP)

(73) Assignee: TDK CORPORATION, Tokyo (JP)

(21) Appl. No.: 18/283,968

(22) PCT Filed: Mar. 28, 2022
(86) PCT No.: PCT/JP2022/014887

§ 371 Date: Sep. 25, 2023

(30) Foreign Application Priority Data
Mar. 29, 2021 (JP) 2021-054538

(51) Int. Cl. H01M 10/0562

(52) U.S. Cl. CPC H01M 10/0562; H01M 2300/008

(57) ABSTRACT

A solid electrolyte material has a pair of surfaces which face each other and includes at least one of a predetermined halide-based solid electrolyte or a predetermined sulfide-based solid electrolyte, in which a surface ten-point average roughness Rz_{JIS} of at least one of the pair of surfaces falls in the range from 20 nm or more and 1500 nm or less.

### TECHNICAL FIELD

The present invention relates to a solid electrolyte material and an all-solid-state battery.

Priority is claimed on Japanese Patent Application No. 2021-054538, filed Mar. 29, 2021, the content of which is incorporated herein by reference. battery.

### BACKGROUND ART

In recent years, the development of electronics techniques has been significant and efforts in which the size, the weight, the thickness, and the multi-functions of portable electronic devices are reduced have been provided. Along with this, there is a strong demand for batteries which serve as power sources for electronic devices to be smaller, lighter, thinner, and more reliable. For this reason, all-solid-state batteries using a solid electrolyte as an electrolyte has attracted attention. As solid electrolytes, oxide-based solid electrolytes, sulfide-based solid electrolytes, halide-based solid electrolyte, complex hydride-based solid electrolyte (LiBH₄ and the like), and the like are known.

As the oxide-based solid electrolytes, Nasicon type solid electrolytes such as Li_{1.3}Al_{0.3}Ti_{1.7}(PO₄)₃(LATP), Perovskite type solid electrolytes such as La_{0.51}Li_{0.34}TiO_{2.94}, and Garnet type solid electrolytes such as Li₇La₃Zr₂O₁₂ are known.

Patent Document 1 discloses, as an all-solid-state battery using a halide-based solid electrolyte, a battery which has a positive electrode including a positive electrode layer including a positive electrode active material containing a Li element and a positive electrode current collector, a negative electrode including a negative electrode layer including a negative electrode active material and a negative electrode current collector, and a solid electrolyte disposed between the positive electrode layer and the negative electrode layer and made of a compound represented by the following general expression:

Li_{3-2X}M_{X}In_{1-Y}M′_{Y}L_{6-Z}L′_{Z}

(where, M and M′ are metal elements and L and L′ are halogen elements. Furthermore, X, Y, and Z independently satisfy 0≤X<1.5, 0≤Y<1, 0≤Z≤6 ).

Patent Document 2 discloses a halide-based solid electrolyte material represented by the following compositional expression:

Li_{6-3Z}Y_{Z}X₆

where, 0<Z<2 is satisfied and X is Cl or Br.

Also, Patent Document 2 describes a battery in which at least one of a negative electrode and a positive electrode includes the solid electrolyte material.

Patent Document 3 discloses, as an all-solid-state battery using a sulfide-based solid electrolyte, a battery which includes an electrode active material layer including an active material, a first solid electrolyte material in contact with the active material, having an anion component different from an anion component of the active material, and being a single-phase mixed electron-ion conductor, and a second solid electrolyte material in contact with the first solid electrolyte material, having the same anion component as the first solid electrolyte material, and being an ionic conductor which does not have electronic conductivity. Furthermore, Patent Document 3 discloses that the first solid electrolyte material is Li₂ ZrS₃, the first solid electrolyte material has a Li₂ZrS₃ peak at a position in which 2θ=34.2°±0.5° is satisfied in X-ray diffraction measurement using CuKα rays and has an I_{B}/I_{A} value of 0.1 or less when diffraction intensity of the Li₂ZrS₃ peak at a position in which 2θ=34.2°±0.5° is satisfied is I_{A} and a diffraction intensity of a ZrO₂ peak at a position in which 2θ=31.4°±0.5° is satisfied is I_{B}.

### CITATION LIST

### Patent Document

### [Patent Document 1]

[Patent Document 1] Japanese Unexamined Patent Application, First Publication No. 2006-244734 (A)

[Patent Document 2] PCT International Publication No. WO 2018/025582 (A)

[Patent Document 3] Japanese Unexamined Patent Application, First Publication No.2013-257992 (A)

### SUMMARY OF INVENTION

### Technical Problem

However, in all-solid-state batteries in the related art, the ionic conductivities of solid electrolytes are insufficient. For this reason, all-solid-state batteries using solid electrolytes in the related art have a problem of low discharge capacity at high current densities, that is, poor rate characteristics.

The present invention was made in view of the above problems, and an object of the present invention is to provide a solid electrolyte material having high ionic conductivity and an all-solid-state battery including the same and having improved rate characteristics.

### Solution to Problem

The inventors of the present invention have made extensive studies to solve the above problems. As a result, the inventors found that an all-solid-state battery in which a solid electrolyte material which includes at least one of a halide-based solid electrolyte and a sulfide-based solid electrolyte and has been subjected to a roughening treatment so that a surface thereof has a surface ten-point average roughness Rz_{JIS} in the range of 20 nm or more and 1500 nm or less is used has improved rate characteristics, thereby conceiving the present invention.

That is to say, the present invention provides the following means to solve the above problems.

[1] A solid electrolyte material having a pair of surfaces facing each other and including at least one of a halide-based solid electrolyte and a sulfide-based solid electrolyte represented by the following Expression (1):

Li₂₊ₐE_{1-b}G_{b}D_{c}X_{d} (1)

(in Expression (1), E is at least one element selected from the group consisting of Al, Sc, Y, Zr, Hf, and lanthanoids, G is at least one element selected from the group consisting of Na, K, Rb, Cs, Mg, Ca, Sr, Ba, B, Si, Ti, Cu, Nb, Ag, In, Sn, Sb, Ta, W, Au, and Bi, D is at least one group selected from the group consisting of CO₃, SO₄, BO₃, PO₄, NO₃, SiO₃, OH, and O₂, X is at least one selected from the group consisting of F, Cl, Br, and I, and a, b, c, and d are numbers which satisfy 0≤a<1.5, 0≤b<0.5, 0≤c≤5, and 0<d≤6.1 ), in which at least one of the pair of surfaces has a surface ten-point average roughness Rz_{JIS} in a range of 20 nm or more and 1500 nm or less.

[2] In the solid electrolyte material according to the above [1], the solid electrolyte material has an average thickness of 2.0 μm or more.

An all-solid-state battery includes: the solid electrolyte material according to the above [1] or [2]; a positive electrode mixture layer in contact with one of the pair of surfaces of the solid electrolyte material; and a negative electrode mixture layer in contact with the other of the pair of surfaces of the solid electrolyte material.

### Advantageous Effects of Invention

According to the present invention, it is possible to provide a solid electrolyte material having high ionic conductivity and an all-solid-state battery including the same and having improved rate characteristics.

### BRIEF DESCRIPTION OF DRAWINGS

FIG. 1 is a schematic cross-sectional view of an all-solid-state battery according to an embodiment of the present invention.

FIG. 2 is an SEM photograph of a surface of a solid electrolyte pellet prepared in Example 1 which has been subjected to roughening treatment.

FIG. 3 is an SEM photograph of a surface of a solid electrolyte pellet prepared in Example 1 which is not subject to roughening treatment.

### DESCRIPTION OF EMBODIMENTS

A solid electrolyte material and an all-solid-state battery according to an embodiment of the present invention will be described in detail below.

### [Solid Electrolyte Material]

The solid electrolyte material in this embodiment has a pair of surfaces that face each other. The “pair of surfaces facing each other” described herein means, for example, two surfaces which are exposed in different directions (such as opposite directions) from each other. The solid electrolyte material is used as the solid electrolyte layer in the all-solid-state battery. When used as the solid electrolyte layer for the all-solid-state battery, one of the pairs of surfaces of the solid electrolyte material is in contact with the positive electrode mixture layer and the other is in contact with a negative electrode mixture layer.

The solid electrolyte material may have any shape as long as it has a pair of surfaces and may have, for example, a film shape (layer shape) or a pellet shape. A surface ten-point average roughness Rz_{JIS} of at least one of the pair of surfaces of the solid electrolyte material falls in the range of 20 nm or more and 1500 nm or less and has fine unevenness. A surface of the solid electrolyte material having fine unevenness may be on a side in contact with a positive electrode mixture layer or a side in contact with the negative electrode mixture layer. It is preferable that both of the pairs of surfaces of the solid electrolyte material have fine unevenness.

The surface ten-point average roughness Rz_{JIS} is obtained by performing sampling by a reference length from a roughness curve in a direction of an average line thereof, obtaining a sum of an average value of absolute values of heights from the highest peak to the fifth peak and an average value of absolute values of heights from the lowest valley bottom to the fifth valley bottom which have been measured in a direction of longitudinal magnification from an average line of this sampled portion, and expressing this value in nanometers.

The solid electrolyte material may have an average thickness of 2.0 μm or more. A thickness of the solid electrolyte material is a distance between the pair of surfaces. The thickness of the solid electrolyte material can be measured by observing a cross section of a cross-section polished sample using a scanning electron microscope (SEM). An average thickness is an average of thicknesses measured at 10 locations. The 10 locations at which measurement is to be performed are preferably spaced from each other, and more preferably spaced from each other by 10% or more of a maximum length (maximum diameter) on each surface of the solid electrolyte material. An average thickness of the solid electrolyte material is preferably 2.0 μm or more, and particularly preferably 10 μm or more. The average thickness of the solid electrolyte material may be 1000 μm or less.

The solid electrolyte material includes at least one of a halide-based solid electrolyte and a sulfide-based solid electrolyte. That is to say, the solid electrolyte material includes at least one of a plurality of compounds listed as a halide-based solid electrolyte and a plurality of compounds listed as a sulfide-based solid electrolyte. The solid electrolyte material may be a single halide-based solid electrolyte, a single sulfide-based solid electrolyte, or a mixture of a halide-based solid electrolyte and a sulfide-based solid electrolyte. The solid electrolyte material may contain a binder.

A compound represented by the following Expression (1) is used as the halide-based solid electrolyte:

Li₂₊ₐE_{1-b}G_{b}D_{c}X_{d} (1)

In the compound represented by Expression (1), E is an essential component and one of the elements forming the skeleton of the compound represented by Expression (1). E is at least one element selected from the group consisting of Al, Sc, Y, Zr, Hf, and lanthanoids (La, Ce, Pr, Nd, Pm, Sm, Eu, Gd, Tb, Dy, Ho, Er, Tm, Yb, and Lu).

Inclusion of E results in a solid electrolyte having a wide potential window and high ionic conductivity. E preferably includes Al, Sc, Y, Zr, Hf and La, and particularly preferably Zr and Y to provide a solid electrolyte having higher ionic conductivity.

In the compound represented by Expression (1), G is a component to be contained if necessary. G is at least one element selected from the group consisting of Na, K, Rb, Cs, Mg, Ca, Sr, Ba, B, Si, Ti, Cu, Nb, Ag, In, Sn, Sb, Ta, W, Au, and Bi. In the compound represented by Expression (1), among the above, G may be a monovalent element selected from Na, K, Rb, Cs, Ag, and Au. In the compound represented by Expression (1), among the above, G may be a divalent element selected from Mg, Ca, Sr, Ba, Cu, and Sn. In the compound represented by Expression (1), among the above, G may be a trivalent element selected from B, Si, Ti, Nb, In, Sb, Ta, W, and Bi.

In the compound represented by Expression (1), D is a component to be contained if necessary. D is at least one group selected from the group consisting of CO₃, SO₄, BO₃, PO₄, NO₃, SiO₃, OH, and O₂. Inclusion of D widens a potential window on a reduction side. D is preferably at least one group selected from the group consisting of SO₄ and CO₃, and particularly preferably SO₄.

In the compound represented by Expression (1), X is an essential component and one of the elements forming the skeleton of the compound represented by Expression (1). X is at least one halogen element selected from the group consisting of F, Cl, Br, and I. X has a large ionic radius per valence. For this reason, when X is contained in the compound represented by Expression (1), lithium ions are more likely to move and the effect of increasing ionic conductivity is obtained. As X, it is preferable to contain Cl because the solid electrolyte has high ionic conductivity.

In the compound represented by Expression (1), a, b, c, and d are numbers satisfying 0≤a<1.5, 0≤b<0.5, 0≤c≤5, and 0<d≤6.1, respectively. It is preferable that 0≤a<1.0, 0≤b<0.35, 0≤c≤3, and 1.5<d≤6.1.

Examples of the compounds represented by Expression (1) include Li₂ZrCl₆, Li₂ZrSO₄Cl₄, Li₂ZrCO₃Cl₄, Li₃YSO₄Cl₄, and Li₃YCO₃Cl₄.

The compound represented by Expression (1) can be produced, for example, using a method for mixing and reacting raw material powders containing predetermined elements at a predetermined molar ratio. The compound represented by Expression (1) can be produced, for example, using a mechanochemical method. For example, a planetary ball mill device can be used as a mixing device for raw material powders to cause a mechanochemical reaction. The planetary ball mill device is a device which puts media (balls for grinding or promoting mechanochemical reaction) and raw material powder into a closed container, rotates and revolves, and applies kinetic energy to a raw material powder to cause a pulverization or mechanochemical reaction. For example, a container and balls made of zirconia can be used as the sealed container and balls of the planetary ball mill device.

Compounds containing Li, S, and Si and/or P can be used as sulfide-based solid electrolytes. The sulfide-based solid electrolyte may further contain Ge, Cl, Br, or I. The sulfide-based solid electrolyte may be amorphous, crystalline, or of an argyrodite type. Examples of sulfide-based solid electrolytes include Li₂S—P₂S₅-based solid electrolytes (Li₇P₃S₁₁, Li₃PS₄, Li₈P₂S₉, and the like), Li₂S—SiS₂, LiI—Li₂S—SiS₂, LiI—Li₂S—P₂S₅, LiI—LiBr—Li₂S—P₂S₅, Li₂S—P₂S₅—GeS₂-based solid electrolytes (Li₁₃GeP₃S₁₆, Li₁₀GeP₂S₁₂, and the like), LiI—Li₂S—P₂O₅, LiI—Li₃PO₄-P₂S₅, and Li₇-xPS₆-xClₓ (x is 1.0 to 1.9 ).

The sulfide-based solid electrolyte may be a compound represented by the following Expression (2):

Li_{q}MᵣPₛOₜXᵤSᵥ (2)

where, Li is lithium, M is a tetravalent metal, P is phosphorus, O is oxygen, S is sulfur, X is at least one selected from the group consisting of F, Cl, Br, and I, and q, r, s, t, u, and v are numbers which satisfy 1≤q≤20, 0≤r≤2, 1≤s≤5, 0≤t≤5, 0≤u≤5, and v=q/2+2×r+2.5×s−t−u/2, respectively. It is preferably M be Si or Ge.

The solid electrolyte material can be produced, for example, by preparing a flat solid electrolyte material having a surface ten-point average roughness Rz_{JIS} of a pair of surfaces of less than 20 nm and then subjecting a surface of the solid electrolyte material to roughening treatment to form fine unevenness. A pressing method, a rolling method, and a coating method can be used as a method for preparing a solid electrolyte material.

The pressing method is a method for preparing a solid electrolyte material with a pellet shape by pressing the solid electrolyte using a pellet preparation jig having a cylindrical holder (die) and an upper punch and a lower punch which can be inserted into this cylindrical holder. Specifically, the lower punch is inserted into the cylindrical holder, the solid electrolyte is put on the lower punch, and then the upper punch is inserted above the solid electrolyte. Furthermore, a solid electrolyte material with a pellet shape can be prepared by placing the pellet preparation jig on a press machine and performing pressing using the lower punch and upper punch.

The rolling method is a method for preparing a solid electrolyte material with a film shape by rolling a solid electrolyte composition containing a solid electrolyte and a binder using pressure rollers. Specifically, the solid electrolyte powder and binder are mixed in a dry manner to obtain a solid electrolyte composition. Subsequently, a solid electrolyte material with a film shape can be prepared by rolling the solid electrolyte composition using pressure rollers. As the binder, for example, fluororesin (PTFE) can be used.

The coating method is a method for preparing a solid electrolyte material with a film shape by applying a solid electrolyte coating solution containing a solid electrolyte, a binder, and a solvent to a substrate and drying it. Specifically, a solid electrolyte coating liquid is obtained by mixing a solid electrolyte, a binder, and a solvent. Subsequently, a solid electrolyte material with a film shape can be prepared by applying the solid electrolyte coating solution using a coating device such as a bar coater and drying it. For example, carboxymethyl cellulose (CMC) can be used as the binder.

An electron beam irradiation method can be used as a method for roughening a surface of the solid electrolyte material. The electron beam irradiation method is a method for forming fine unevenness on a surface of the solid electrolyte material by irradiating the surface of the solid electrolyte material with electron beams. By using this electron beam irradiation method, it is possible to obtain a solid electrolyte material in which at least one of the pair of surfaces has a surface ten-point average roughness Rz_{JIS} in the range of 20 nm or more and 1500 nm or less.

The solid electrolyte material of this embodiment constituted as described above has a pair of surfaces facing each other and at least one of the pair of surfaces has a surface ten-point average roughness Rz_{JIS} of 20 nm or more. For this reason, a contact area between the solid electrolyte material and the adjacent electrode mixture layer (positive electrode mixture layer, negative electrode mixture layer) can be increased by using this solid electrolyte material as a solid electrolyte layer of an all-solid-state battery. Thus, the contact resistance between the solid electrolyte material and the electrode mixture layer can be lowered and the ionic conductivity between the solid electrolyte material and the electrode mixture layer is improved. Furthermore, since a surface of the solid electrolyte material has a surface ten-point average roughness Rz_{JIS} of 1500 nm or less, it is considered that a potential distribution is uniform and electrical deterioration is less likely to occur locally. For this reason, an all-solid-state battery using the solid electrolyte material of this embodiment as a solid electrolyte layer has improved rate characteristics.

Also, in the solid electrolyte material of this embodiment, when the average thickness is 2.0 μm or more, a solid electrolyte material thickness is more than a surface roughness. Thus, it is considered that local strength reduction and breakage due to surface irregularities are less likely to occur.

### [All-Solid-State Battery]

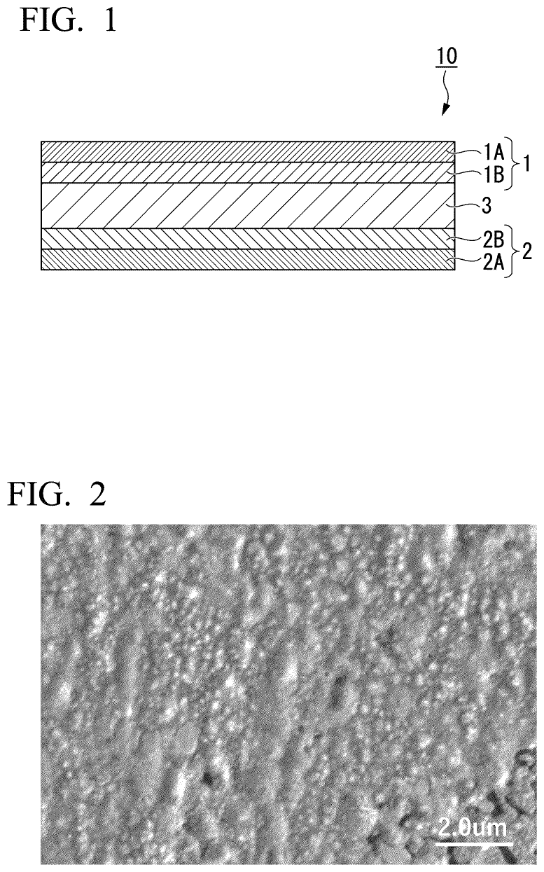

FIG. 1 is a schematic cross-sectional view of an all-solid-state battery according to an embodiment of the present invention.

An all-solid-state battery 10 shown in FIG. 1 includes a positive electrode 1, a negative electrode 2, and a solid electrolyte layer 3.

The solid electrolyte layer 3 is disposed between the positive electrode 1 and the negative electrode 2. The solid electrolyte layer 3 uses the solid electrolyte material described above.

External terminals (not shown) are connected to the positive electrode 1 and the negative electrode 2 and are electrically connected to the outside.

The all-solid-state battery 10 is charged or discharged using the transfer of ions through the solid electrolyte layer 3 and electrons through an external circuit between the positive electrode 1 and the negative electrode 2. The all-solid-state battery 10 may be a laminated body in which the positive electrode 1, the negative electrode 2 and the solid electrolyte layer 3 are laminated or may be a wound body in which the laminated body is wound. The all-solid-state battery can be, for example, a laminate battery, a prismatic battery, a cylindrical battery, a coin battery, or a button battery.

### (Positive Electrode)

As shown in FIG. 1, the positive electrode 1 is formed by providing a positive electrode mixture layer 1B on a plate-like (foil-like) positive electrode current collector 1A. The positive electrode 1 is disposed so that the positive electrode mixture layer 1B is adjacent to the solid electrolyte layer 3.

### (Positive Electrode Current Collector)

A positive electrode current collector 1A may be made of a material with electronic conductivity which is resistant to oxidation and corrosion during charging. As the positive electrode current collector 1A, for example, metals such as aluminum, stainless steel, nickel, and titanium or conductive resins can be used. The positive electrode current collector 1A may have a form of a powder, a foil, or a punched or expanded form.

### (Positive Electrode Mixture Layer)

The positive electrode mixture layer 1B contains a positive electrode active material and, if necessary, a solid electrolyte, a binder, and a conductive auxiliary agent.

### (Positive Electrode Active Material)

The positive electrode active material is not particularly limited as long as it is capable of reversibly promoting absorption/release, insertion/deintercalation (intercalation/deintercalation) of lithium ions. As the positive electrode active material, a positive electrode active material used for known lithium ion secondary batteries can be used. Examples of the positive electrode active materials include lithium-containing metal oxides and lithium-containing metal phosphates.

Examples of the lithium-containing metal oxides include lithium cobalt oxide (LiCoO₂), lithium nickel oxide (LiNiO₂), lithium manganese spinel (LiMn₂O₄), and composite metal oxides represented by the general expression: LiNiₓCo_{y}Mn_{z}O₂ (x+y+z=1), lithium vanadium compounds (LiVOPO₄, Li₃V₂(PO₄)₃), olivine-type LiMPO₄ (where M represents at least one selected from Co, Ni, Mn, and Fe), lithium titanate (Li₄Ti₅O₁₂), and the like.

Also, positive electrode active materials which do not contain lithium can also be used. As such a positive electrode active material, lithium-free metal oxides (MnO₂, V₂O₅, and the like), lithium-free metal sulfides (MoS₂, and the like), lithium-free fluorides (FeF₃, VF₃, and the like), and the like are exemplified.

When using these lithium-free positive electrode active materials, a negative electrode may be doped with lithium ions in advance or a negative electrode containing lithium ions may be used.

### (Solid Electrolyte)

The solid electrolyte may be the same as or different from the solid electrolyte contained in solid electrolyte layer 3. When the solid electrolyte in the positive electrode mixture layer 1B and the solid electrolyte in the solid electrolyte layer 3 are the same, the ionic conductivity between the positive electrode mixture layer 1B and the solid electrolyte layer 3 is improved.

Although the content rate of the solid electrolyte in the positive electrode mixture layer 1B is not particularly limited, the content rate is preferably 1% to 50% by volume, and more preferably 5% to 50% by volume on the basis of the total volume of the positive electrode active material, the solid electrolyte, the conductive auxiliary agent, and the binder.

### (Binder)

The binder mutually binds the positive electrode active material, the solid electrolyte, and the conductive auxiliary agent which constitute the positive electrode mixture layer 1B. Furthermore, the binder adheres the positive electrode mixture layer 1B and the positive electrode current collector 1A. Properties required for the binder include oxidation resistance and good adhesion.

As the binder used for the positive electrode mixture layer 1B, polyvinylidene fluoride (PVDF) or a copolymer thereof, polytetrafluoroethylene (PTFE), polyamide (PA), polyimide (PI), polyamideimide (PAI), polybenzimidazole (PBI), polyethersulfone (PES), polyacrylic acid (PA) and a copolymer thereof, polyacrylic acid (PA) and a metal ion crosslinked product of a copolymer thereof, maleic anhydride-grafted polypropylene (PP), maleic anhydride-grafted polyethylene (PE), or a mixture of these are exemplified. Among these, it is particularly preferable to use PVDF as the binder.

Although the content rate of the binder in the positive electrode mixture layer 1B is not particularly limited, the content rate is preferably 1% to 15% by volume, and more preferably 3% to 5% by volume on the basis of the total volume of the positive electrode active material, the solid electrolyte, the conductive auxiliary agent, and the binder. If the proportional content of the binder is too low, it tends to fail to form a positive electrode 1 with sufficient adhesive strength. Furthermore, a typical binder is electrochemically inactive and does not contribute to discharge capacity. For this reason, if the content rate of the binder is too high, it tends to be difficult to obtain sufficient volumetric or mass energy density.

### (Conductive Auxiliary Agent)

The conductive auxiliary agent is not particularly limited as long as it improves the electronic conductivity of the positive electrode mixture layer 1B and known conductive auxiliary agents can be used. Examples thereof include carbon materials such as carbon black, graphite (graphite), carbon nanotubes, and graphene, metals such as aluminum, copper, nickel, stainless steel, iron, and amorphous metals, conductive oxides such as ITO, and mixtures thereof. The conductive auxiliary agent may have a form of a powder or a fiber.

The content rate of the conductive auxiliary agent in the positive electrode mixture layer 1B is not particularly limited. When the positive electrode mixture layer 1B contains the conductive auxiliary agent, the conductive auxiliary agent is preferably 0.5% to 20% by volume, and more preferably 1% to 10% by volume on the basis of the total volume of the positive electrode active material, the solid electrolyte, the conductive auxiliary agent, and the binder.

### (Negative Electrode)

As shown in FIG. 1, the negative electrode 2 is a negative electrode mixture layer 2B provided on a negative electrode current collector 2A. The negative electrode 2 is disposed so that the negative electrode mixture layer 2B is adjacent to the solid electrolyte layer 3.

### (Negative Electrode Current Collector)

The negative electrode current collector 2A may have electronic conductivity. As the negative electrode current collector 2A, for example, metals such as copper, aluminum, nickel, stainless steel, and iron or conductive resins can be used. The negative electrode current collector 2A may have a form of a powder, a foil, or a punched, or expanded form.

### (Negative Electrode Mixture Layer)

The negative electrode mixture layer 2B contains a negative electrode active material and, if necessary, a solid electrolyte, a binder and a conductive auxiliary agent.

### (Negative Electrode Active Material)

The negative electrode active material is not particularly limited as long as it can reversibly absorb and desorb lithium ions and intercalate and deintercalate lithium ions. As the negative electrode active material, a known negative electrode active material used for lithium ion secondary batteries can be used.

Examples of the negative electrode active materials include carbon materials such as natural graphite, artificial graphite, mesocarbon microbeads, mesocarbon fibers (MCF), cokes, vitreous carbon, sintered organic compounds, metals such as Si, SiOₓ, Sn, and aluminum which can combine with lithium alloys, composite materials of these metals and carbon materials, lithium titanate (Li₄Ti₅O₁₂), oxides such as SnO₂, metallic lithium, and the like.

### (Solid Electrolyte)

The solid electrolyte may be the same as or different from the solid electrolyte contained in solid electrolyte layer 3. When the solid electrolyte in the negative electrode mixture layer 2B and the solid electrolyte in the solid electrolyte layer 3 are the same, the ionic conductivity between the negative electrode mixture layer 2B and the solid electrolyte layer 3 is improved.

Although the content rate of the solid electrolyte in the negative electrode mixture layer 2B is not particularly limited, the content rate is preferably 1% to 50% by volume, and more preferably 5% to 50% by volume on the basis of the total volume of the negative electrode active material, the solid electrolyte, the conductive auxiliary agent, and the binder.

### (Binder)

The binder mutually binds the negative electrode active material, the solid electrolyte, and the auxiliary conductive agent which constitute the negative electrode mixture layer 2B. Furthermore, the binder adheres the negative electrode mixture layer 2B and the negative electrode current collector 2A. Properties required for the binder include resistance to reduction and good adhesion.

As the binder used for the negative electrode mixture layer 2B, polyvinylidene fluoride (PVDF) or a copolymer thereof, polytetrafluoroethylene (PTFE), polyamide (PA), polyimide (PI), polyamideimide (PAI), polybenzimidazole (PBI), styrene-butadiene rubber (SBR), carboxymethylcellulose (CMC), polyacrylic acid (PA) and a copolymer thereof, polyacrylic acid (PA) and a copolymer metal ion crosslinked product thereof, maleic anhydride-grafted polypropylene (PP), maleic anhydride-grafted polyethylene (PE), mixtures thereof, and the like are exemplified. Among these, it is preferable to use one or more selected from SBR, CMC, and PVDF as the binder.

Although the content rate of the binder in the negative electrode mixture layer 2B is not particularly limited, the content rate is preferably 1% to 15% by volume, and more preferably 1.5% to 10% by volume on the basis of the total volume of the negative electrode active material, the conductive auxiliary agent, and the binder. If the content rate of the binder is too low, it tends to fail to form a negative electrode 2 with sufficient adhesive strength. Furthermore, a typical binder is electrochemically inactive and does not contribute to the discharge capacity. For this reason, if the content rate of the binder is too high, it tends to be difficult to obtain sufficient volumetric or mass energy density.

### (Conductive Auxiliary Agent)

A carbon material, a metal, a conductive oxide, or a mixture thereof can be used as a conductive auxiliary agent which may be contained in the negative electrode mixture layer 2B. Examples of the carbon materials, the metals, and the conductive oxides are the same as for the conductive auxiliary agent which may be included in the positive electrode mixture layer 1B described above.

The content rate of the conductive auxiliary agent in the negative electrode mixture layer 2B is not particularly limited. When the negative electrode mixture layer 2B contains a conductive auxiliary agent, the conductive auxiliary agent is preferably 0.5% to 20% by volume, and more preferably 1% to 10% by volume on the basis of the total volume of the negative electrode active material, the solid electrolyte, the conductive auxiliary agent, and the binder.

### (Exterior Body)

In the all-solid-state battery of this embodiment, the battery element including the positive electrode 1, the solid electrolyte layer 3, and the negative electrode 2 is accommodated in an exterior body and sealed. The exterior body is not particularly limited as long as it can prevent moisture from entering from the outside to the inside.

For example, as the exterior body, a metal laminate film formed by coating both sides of a metal foil with a polymer film can be used in the form of a bag. Such an exterior body is hermetically sealed by heat-sealing the opening.

As the metal foil forming the metal laminate film, for example, an aluminum foil, a stainless steel foil, or the like can be used. For the polymer films disposed on the outer side of the exterior body, it is preferable to use a polymer having a high melting point, and for example, it is preferable to use polyethylene terephthalate (PET), polyamide, or the like. For the polymer films disposed on the inner side of the exterior body, it is preferable to use, for example, polyethylene (PE), polypropylene (PP), or the like.

### (External Terminal)

A positive electrode terminal is electrically connected to the positive electrode 1 that is a battery element. Furthermore, a negative electrode terminal is electrically connected to the negative electrode 2. In this embodiment, the positive electrode terminal is electrically connected to the positive electrode current collector 1A. In addition, the negative electrode terminal is electrically connected to the negative electrode current collector 2A. The connection portion between the positive electrode current collector 1A or the negative electrode current collector 2A and the external terminals (positive electrode terminal and negative electrode terminal) is disposed inside the exterior body.

As the external terminal, for example, a terminal made of a conductive material such as aluminum or nickel can be used.

It is preferable that a film made of maleic anhydride-grafted PE (hereinafter may be referred to as “acid-modified PE” in some cases) or maleic anhydride-grafted PP (hereinafter may be referred to as “acid-modified PP” in some cases) be disposed between the exterior body and the external terminal. An all-solid-state battery with good adhesion between the exterior body and the external terminal is obtained by heat-sealing the portion in which the acid-modified PE or acid-modified PP film is disposed.

A method for producing the all-solid-state battery 10 will be described below.

First, the solid electrolyte material which will be the solid electrolyte layer 3 of the all-solid-state battery 10 is prepared. Subsequently, the positive electrode mixture layer 1B is formed on one surface of the solid electrolyte material and the negative electrode mixture layer 2B is formed on the other surface. As a method for forming the positive electrode mixture layer 1B and the negative electrode mixture layer 2B, a press method, a coating method, or a crimping method can be used.

The press method is a method for forming the pellet-shaped positive electrode mixture layer 1B and the negative electrode mixture layer 2B by pressurizing the positive electrode mixture disposed on one surface of the solid electrolyte material and the negative electrode mixture disposed on the other surface using a pellet preparation jig having a cylindrical holder (die) and upper and lower punches which can be inserted into this cylindrical holder. Specifically, the solid electrolyte material is inserted into the cylindrical holder. Subsequently, after injecting the negative electrode mixture onto one surface of the solid electrolyte material, the lower punch is inserted above the negative electrode mixture. Subsequently, after reversing the direction of the solid electrolyte material and injecting the positive electrode mixture onto the other surface of the solid electrolyte material, the upper punch is inserted above the positive electrode mixture. Furthermore, the pellet-shaped positive electrode mixture layer 1B and the negative electrode mixture layer 2B can be prepared by placing the pellet preparation jig on the press machine and performing pressing using the lower punch and the upper punch.

The coating method is a method for forming the film shape negative electrode mixture layer 2B by coating one surface of the solid electrolyte material with the negative electrode mixture coating liquid and drying it and forming the film shape positive electrode mixture layer 1B by coating the other surface of the solid electrolyte material with the positive electrode mixture coating solution and drying it. Specifically, the negative electrode mixture and a solvent are mixed to obtain a negative electrode mixture coating solution and the positive electrode mixture and a solvent are mixed to obtain a positive electrode mixture coating solution. Subsequently, the negative electrode mixture coating solution is applied to one surface of the solid electrolyte material using a coating device such as a bar coater and then dried so that the film shape negative electrode mixture layer 2B is formed. Subsequently, the direction of the solid electrolyte material is reversed, and similarly, the positive electrode mixture coating solution is applied to the other surface of the solid electrolyte material and then dried so that the positive electrode mixture layer 1B with a film shape is formed.

The crimping method is a method for creating a solid electrolyte material, a film shape positive electrode mixture, and a negative electrode mixture with a film shape, laminating the positive electrode mixture layer 1B with a film shape on one surface of the solid electrolyte material and the negative electrode mixture layer 2B with a film shape on the other surface, respectively, and performing pressing by pressurizing the obtained laminated body.

In this way, a laminated body in which the positive electrode mixture layer 1B, the solid electrolyte layer 3, and the negative electrode mixture layer 2B are laminated in this order is obtained. A laminated body in which the positive electrode 1, the solid electrolyte layer 3, and the negative electrode 2 are laminated in this order is obtained by crimping the positive electrode current collector 1A on the surface of the positive electrode mixture layer 1B of the obtained laminated body and the negative electrode current collector 2A on the surface of the negative electrode mixture layer 2B, respectively.

Subsequently, external terminals are welded, using a known method, to the positive electrode current collector 1A of the positive electrode 1 and the negative electrode current collector 2A of the negative electrode 2 forming the obtained laminated body and the positive electrode current collector 1A or the negative electrode current collector 2A is electrically connected to the external terminal. After that, the laminated body connected to the external terminal is accommodated in the exterior body and the opening of the exterior body is sealed by heat sealing.

Through the above steps, the all-solid-state battery 10 of this embodiment is obtained.

Since the all-solid-state battery 10 of this embodiment constituted as described above has the solid electrolyte layer 3 as the above-described solid electrolyte material, the rate characteristics are improved.

Although the embodiment of the present invention has been described in detail with reference to the drawings, each constitution and a combination thereof in each embodiment is an example and additions, omissions, substitutions, and other modifications in constitution are possible without departing from the spirit of the present invention.

### EXAMPLES

### Example 1

### (1) Preparation of Solid Electrolyte

Lithium chloride (LiCl) and zirconium chloride (ZrCl₄) were mixed at a molar ratio of 2:1 (=LiCl:ZrCl₄) to obtain a raw material powder mixture. The raw material powder mixture was set to have the number of rotations of 500 rpm and the number of revolutions of 500 rpm using a planetary ball mill device and mixed and react for 24 hours assuming that a rotation direction of rotation and a rotation direction of revolution are opposite directions so that a solid electrolyte (Li₂ZrCl₆) was generated. A sealed container and balls for a planetary ball mill were made of zirconia.

### (2) Preparation of Negative Electrode Mixture

A negative electrode mixture was obtained by weighing out lithium titanate (Li₄Ti₅O₁₂, LTO), the solid electrolyte (Li₂ZrCl₆) obtained in (1) above, and graphite (C) at a volume ratio of 4:5:1 (=LTO:Li₂ZrCl₆:C) and mixing it for 15 minutes using a pestle and a mortar made of agate.

### (3) Preparation of Positive Electrode Mixture

A positive electrode mixture was obtained by weighing lithium cobalt oxide (LiCoO₂), the solid electrolyte (Li₂ZrCl₆) obtained in (1) above, and graphite (C) at a volume ratio of 4:5:1 (=LiCoO₂:Li₂ZrCl₆:C) and mixing it for 15 minutes using a pestle and a mortar made of agate.

### (4) Preparation of Solid Electrolyte Pellet

A solid electrolyte pellet with a diameter of 10 mm was prepared by processing the solid electrolyte (Li₂ZrCl₆) obtained in (1) above as follows using a pellet preparation jig. The pellet preparation jig had a 10 mm diameter resin holder and 9.99 mm diameter upper and lower punches. The material of the upper and lower punches was die steel (SKD material).

The lower punch was inserted into the resin holder of the pellet preparation jig and the solid electrolyte was put on the lower punch. Subsequently, the upper punch was inserted above the solid electrolyte. The pellet preparation jig was placed on a press machine and pressurized with a molding pressure of 24 tons. The pellet preparation jig was removed from the press machine and the solid electrolyte pellet was removed from the pellet preparation jig.

The solid electrolyte pellet was disposed on an aluminum sample stage and introduced into an electron beam irradiation device. When the electron beam irradiation device is made have a vacuum state and a degree of vacuum reaches a predetermined value (5×10⁻³ Pa), electron beam irradiation was performed under the conditions of a voltage of 5 kV, a current of 500 pA, and a treatment time of 20 seconds to subject one surface of the solid electrolyte pellet to roughening treatment. After the roughening treatment, the solid electrolyte pellet was removed from the electron beam irradiation device, the solid electrolyte pellet was reversed and disposed on an aluminum sample stage, and the other surface of the solid electrolyte pellet was subjected to roughening treatment.

### (5) Preparation of All-Solid-State Battery

The solid electrolyte pellet obtained in (4) above was inserted into a resin holder of the pellet preparation jig. The negative electrode mixture obtained in (2) above was introduced to one surface of the solid electrolyte pellet. The resin holder was vibrated to smooth the surface of the negative electrode mixture and then the lower punch was inserted above the negative electrode mixture and the surface of the negative electrode mixture was smoothed. Subsequently, the orientation of the solid electrolyte pellet was reversed, the positive electrode mixture obtained in (3) above was introduced on the other surface of the solid electrolyte pellet, and the surface of the positive electrode mixture was smoothed in the same way as the negative electrode mixture above, and then the upper punch was inserted on the positive electrode mixture and the surface of the positive electrode mixture was smoothed. A laminated body in which the negative electrode mixture pellet, the solid electrolyte pellet, and the positive electrode mixture pellet were layered in this order was obtained by placing this pellet preparation jig on a press machine and performing pressing with a molding pressure of 24 tons. The obtained laminated body had a diameter of 10 mm and a thickness of 450 μm.

An insulating resin sheet (length 20 mm×width 30 mm×thickness 300 μm) having a through hole of a diameter of 11 mm in a center thereof was prepared and the laminated body was inserted into the through hole of this insulating resin sheet so that the positive electrode mixture layer was exposed on one side of the insulating resin sheet and the negative electrode mixture layer was exposed on the other side. Subsequently, a solid battery cell was prepared by disposing an aluminum foil (positive electrode current collector) on a surface of the positive electrode mixture layer of the laminated body, disposing the aluminum foil (negative electrode current collector) on each surface of the negative electrode mixture layer, and fixing the positive electrode current collector and the negative electrode current collector to the insulating resin sheet using an adhesive tape. An all-solid-state battery was prepared by attaching terminals to the positive electrode current collector and the negative electrode current collector of the obtained solid battery cell, causing the solid battery cell to be accommodated in an aluminum laminate bag so that the terminals are exposed, and sealing the aluminum laminate bag. The all-solid-state battery was prepared in a glove box in an argon gas atmosphere with a dew point of −70° C.

### (6) Evaluation

For the solid electrolyte pellet, surface observation and surface ten-point average roughness Rz_{JIS} were performed using the following methods. Furthermore, the rate characteristics of all-solid-state batteries were measured using the following methods. Table 1 shows the measurement results of surface ten-point average roughness Rz_{JIS} and rate characteristics.

### (Surface Observation)

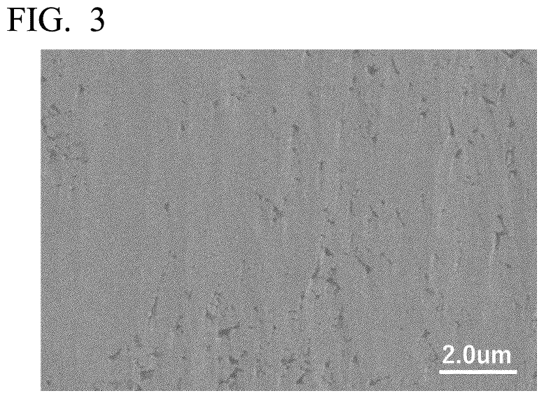

The surface of the solid electrolyte pellet was observed using scanning electron microscope (SEM). FIG. 2 shows an SEM photograph of the surface of the solid electrolyte pellet after roughening treatment and FIG. 3 shows an SEM photograph of the surface of the solid electrolyte pellet before roughening treatment.

### (Surface Ten-Point Average Roughness Rz_{JIS} of Solid Electrolyte Pellet)

A sample for cross-sectional observation was prepared by cutting the solid electrolyte pellet, polishing the cut surface, and then subjecting the polished cut surface to argon ion milling. An area of the cut surface was about 1 mm². The obtained sample was observed using a scanning electron microscope (SEM) to obtain a cross-sectional roughness curve. A sum of an average value of absolute values of heights from the highest peak to the fifth peak and an average value of absolute values of heights from the lowest valley bottom to the fifth valley bottom was calculated from the obtained roughness curve and the obtained value was defined as a surface ten-point average roughness Rz_{JIS}. The surface ten-point average roughness Rz_{JIS} is obtained by performing measurement six times in total, three on each of the upper punch side surface and the lower punch side surface of the solid electrolyte pellet. The surface ten-point average roughness Rz_{JIS} listed in Table 1 is an average value of the surface ten-point average roughness Rz_{JIS} measured six times.

### (Rate Characteristics of All-Solid-State Battery)

Charging and discharging were performed under the following conditions. A voltage range was from 2.8 V to 1.3 V. Charging was performed at a constant current of 0.1 C and was terminated when the current reached 0.05 C after the constant voltage. Discharging was performed at 0.1 C and 1.0 C. A ratio of a discharge capacity at 1.0 C to a discharge capacity at 0.1 C was defined as rate characteristics (%). Furthermore, the result of rate characteristics was determined assuming that a ratio of a 1.0 C discharge capacity to a 0.1 C discharge capacity (discharge capacity of 1.0 C/discharge capacity of 0.1 C) of 0.8 or more was defined as “A,” a ratio of 0.7 or more and less than 0.8 was defined as “B,” and a ratio of less than 0.7 was defined as “C.” A charge/discharge test was performed in a constant temperature bath at 25° C.

### Examples 2 and 3, Comparative Examples 1 and 2

(4) In the preparation of the solid electrolyte pellet, an all-solid-state battery was prepared, as in Example 1, except for the conditions of a voltage, a current, and a treatment time for the roughening treatment as shown in Table 1 which will be shown below and the surface ten-point average roughness Rz_{JIS} of the solid electrolyte pellet and the rate characteristics of the all-solid-state battery were measured. The results are shown in Table 1.

### Examples 4 to 6

(1) In the production of the solid electrolyte, Li₂ZrSO₄Cl₄ was generated by mixing and reacting lithium sulfate (Li₂SO₄) and zirconium chloride (ZrCl₄) at a molar ratio of 1:1 (=Li₂SO₄:ZrCl₄). Furthermore, (2) in the preparation of the negative electrode mixture and (3) the preparation of the positive electrode mixture, Li₂ZrSO₄Cl₄ was used as the solid electrolyte. In addition, (4) in the preparation of the solid electrolyte pellet, Li₂ZrSO₄Cl₄ was used as the solid electrolyte and the conditions of a voltage, a current, and a treatment time for the roughening treatment were set to the conditions shown in Table 1 which will be shown below. Except for the above, an all-solid-state battery was prepared in the same way as in Example 1 and the surface ten-point average roughness Rz_{JIS} of the solid electrolyte pellet and the rate characteristics of the all-solid-state battery were measured. The results are shown in Table 1.

### Examples 7 to 9

(1) In the production of the solid electrolyte, Li₃YCl₆ was generated by mixing and reacting lithium chloride (LiCl) and yttrium chloride (YCl₃) at a molar ratio of 3:1 (=LiCl:YCl₃). Furthermore, (2) in the preparation of the negative electrode mixture and (3) in the preparation of the positive electrode mixture, Li₃YCl₆ was used as the solid electrolyte. In addition, (4) in the production of the solid electrolyte pellet, Li₃YCl₆ was used as the solid electrolyte and the conditions of a voltage, a current, and a treatment time for the roughening treatment were set to the conditions shown in Table 1 which will be shown below. Except for the above, an all-solid-state battery was prepared in the same way as in Example 1 and the surface ten-point average roughness Rz ns of the solid electrolyte pellet and the rate characteristics of the all-solid-state battery were measured. The results are shown in Table 1.

### Examples 10 to 12

(1) In the production of the solid electrolyte, Li_{2.3}Al_{0.3}Zr_{0.7}Cl₆ was generated by mixing and reacting lithium chloride (LiCl), aluminum chloride (AlCl₃), and zirconium chloride (ZrCl₄) at a molar ratio of 2.3:0.3:0.7 (=LiCl:AlCl₃:ZrCl₄). Furthermore, (2) in the preparation of the negative electrode mixture and (3) the preparation of the positive electrode mixture, Li_{2.3}Al_{0.3}Zr_{0.7}Cl₆ was used as the solid electrolyte. In addition, (4) in the production of the solid electrolyte pellet, Li_{2.3}Al_{0.3}Zr_{0.7}Cl₆ was used as the solid electrolyte and the conditions of a voltage, a current, and a treatment time for the roughening treatment were set to the conditions shown in Table 1 which will be shown below. Except for the above, an all-solid-state battery was prepared in the same way as in Example 1 and the surface ten-point average roughness Rz_{JIS} of the solid electrolyte pellet and the rate characteristics of the all-solid-state battery were measured. The results are shown in Table 1.

### Examples 13 to 15

(1) In the production of the solid electrolyte, Li₂Zr(SiO₂)₂Cl₆ was generated by mixing and reacting lithium chloride (LiCl), zirconium chloride (ZrCl₄), and silicon dioxide (SiO₂) at a molar ratio of 2:1:2 (=LiCl:ZrCl₄:SiO₂). Furthermore, (2) in the preparation of the negative electrode mixture and (3) the preparation of the positive electrode mixture, Li₂Zr(SiO₂)₂Cl₆ was used as the solid electrolyte. In addition, (4) in the preparation of solid electrolyte pellet, Li₂Zr(SiO₂)₂Cl₆ was used as the solid electrolyte and the conditions of a voltage, a current, and a treatment time for the roughening treatment were set to the conditions shown in Table 1 which will be shown below. Except for the above, an all-solid-state battery was prepared in the same way as in Example 1 and the surface ten-point average roughness Rz_{JIS} of the solid electrolyte pellet and the rate characteristics of the all-solid-state battery were measured. The results are shown in Table 1

### Comparative Examples 3 to 5

(2) In the preparation of the negative electrode mixture and (3) the preparation of the positive electrode mixture, Li_{1.3}Al_{0.3}Ti_{1.7}(PO₄)₃ was used as the solid electrolyte. Furthermore, (4) in the preparation of solid electrolyte pellet, Li_{1.3}Al_{0.3}Ti_{1.7}(PO₄)₃ was used as the solid electrolyte and the conditions of a voltage, a current, and a treatment time for the roughening treatment were set to the conditions shown in Table 1 which will be shown below. Except for the above, an all-solid-state battery was prepared in the same way as in Example 1 and the surface ten-point average roughness Rz ns of the solid electrolyte pellet and the rate characteristics of the all-solid-state battery were measured. The results are shown in Table 1.

TABLE 1

| | | | | | Surface | | |
|---|---|---|---|---|---|---|---|
| | | Roughening treatment | | | ten-point | | |
| | | condition | | | average | Rate | Rate |
| | Composition of | Voltage | Current | Time | roughness | characteristics | characteristic |
| | solid electrolyte | (kV) | (pA) | (second) | Rz_{JIS} (nm) | (%) | determination |
| Example 1 | Li₂ZrCl₆ | 5 | 500 | 20 | 25 | 87 | A |
| Example 2 | Li₂ZrCl₆ | 8 | 500 | 20 | 223 | 92 | A |
| Example 3 | Li₂ZrCl₆ | 5 | 1000 | 15 | 1105 | 79 | B |
| Example 4 | Li₂ZrSO₄Cl₄ | 5 | 400 | 20 | 33 | 91 | A |
| Example 5 | Li₂ZrSO₄Cl₄ | 8 | 400 | 20 | 311 | 94 | A |
| Example 6 | Li₂ZrSO₄Cl₄ | 5 | 850 | 15 | 1450 | 78 | B |
| Example 7 | Li₃YCl₆ | 5 | 550 | 20 | 28 | 90 | A |
| Example 8 | Li₃YCl₆ | 8 | 550 | 20 | 225 | 91 | A |
| Example 9 | Li₃YCl₆ | 5 | 1100 | 15 | 1118 | 76 | B |
| Example 10 | Li_{2.3}Al_{0.3}Zr_{0.7}Cl₆ | 5 | 500 | 20 | 27 | 85 | A |
| Example 11 | Li_{2.3}Al_{0.3}Zr_{0.7}Cl₆ | 8 | 500 | 20 | 220 | 93 | A |
| Example 12 | Li_{2.3}Al_{0.3}Zr_{0.7}Cl₆ | 5 | 1000 | 15 | 1113 | 74 | B |
| Example 13 | Li₂Zr(SiO₂)₂Cl₆ | 5 | 500 | 20 | 30 | 84 | A |
| Example 14 | Li₂Zr(SiO₂)₂Cl₆ | 8 | 500 | 20 | 312 | 90 | A |
| Example 15 | Li₂Zr(SiO₂)₂Cl₆ | 5 | 1000 | 15 | 1386 | 75 | B |
| Comparative | Li₂ZrCl₆ | 2 | 300 | 10 | 18 | 45 | C |
| Example 1 | | | | | | | |
| Comparative | Li₂ZrCl₆ | 10 | 1000 | 20 | 1950 | 51 | C |
| Example 2 | | | | | | | |
| Comparative | Li_{1.3}Al_{0.3}Ti_{1.7}(PO₄)₃ | 5 | 800 | 20 | 50 | 51 | C |
| Example 3 | | | | | | | |
| Comparative | Li_{1.3} Al_{0.3}Ti_{1.7}(PO₄)₃ | 8 | 1000 | 25 | 354 | 49 | C |
| Example 4 | | | | | | | |
| Comparative | Li_{1.3}Al_{0.3}Ti_{1.7}(PO₄)₃ | 10 | 500 | 25 | 1250 | 53 | C |
| Example 5 | | | | | | | |

From the SEM photographs of FIGS. 2 and 3, it can be seen that roughening treatment of the solid electrolyte pellet forms a large amount of unevenness on the surface of the solid electrolyte pellet.

From the results in Table 1, it can be seen that all-solid-state batteries of Examples 1 to 3 in which pellets composed of a halide-based solid electrolyte (Li₂ZrCl₆) whose surface ten-point average roughness Rz_{JIS} was in the scope of the present invention were used had improved rate characteristics compared to all-solid-state batteries of Comparative Examples 1 and 2 in which solid electrolyte pellets whose surface ten-point average roughness Rz_{JIS} was outside of the scope of the present invention were used. Furthermore, from the results of Examples 4 to 6, for Li₂ZrSO₄Cl₄, it was confirmed that, if the surface ten-point average roughness Rz_{JIS} was in the scope of the present invention, the rate characteristics of the all-solid-state battery were improved. In addition, from the results of Comparative Examples 3 and 4, for Li_{1.3}Al_{0.3}Ti_{1.7}(PO₄)₃ that was the oxide-based solid electrolyte, it was confirmed that the rate characteristics of the all-solid-state battery were inferior even if the surface ten-point average roughness Rz_{JIS} was in the range of the present invention.

### Examples 16 to 18, Comparative Examples 6 and 7

(2) In the preparation of the negative electrode mixture and (3) the preparation of the positive electrode mixture, Li₆PS₅Cl was used as the solid electrolyte. Furthermore, (4) in the preparation of solid electrolyte pellet, Li₆PS₅Cl was used as the solid electrolyte and the conditions of a voltage, a current, and a treatment time for the roughening treatment were set to the conditions shown in Table 2 which will be shown below. Except for the above, an all-solid-state battery was prepared in the same way as in Example 1 and the surface ten-point average roughness Rz_{JIS} of the solid electrolyte pellet and the rate characteristics of the all-solid-state battery were measured. The results are shown in Table 2.

### Examples 19 to 21

(2) In the preparation of the negative electrode mixture and (3) the preparation of the positive electrode mixture, Li₇P₃S₁₁ was used as the solid electrolyte. Furthermore, (4) in the preparation of solid electrolyte pellet, Li₇P₃S₁₁ was used as the solid electrolyte and the conditions of a voltage, a current, and a treatment time for the roughening treatment were set to the conditions shown in Table 2 which will be shown below. Except for the above, an all-solid-state battery was prepared in the same way as in Example 1 and the surface ten-point average roughness Rz_{JIS} of the solid electrolyte pellet and the rate characteristics of the all-solid-state battery were measured. The results are shown in Table 2.

TABLE 2

| | | | | | Surface | | |
|---|---|---|---|---|---|---|---|
| | | Roughening treatment | | | ten-point | | |
| | Composition | condition | | | average | Rate | Rate |
| | of solid | Voltage | Current | Time | roughness | characteristics | characteristic |
| | electrolyte | (kV) | (pA) | (second) | Rz_{JIS} (nm) | (%) | determination |
| Example 16 | Li₆PS₅Cl | 5 | 300 | 20 | 40 | 75 | B |
| Example 17 | Li₆PS₅Cl | 8 | 300 | 20 | 387 | 78 | B |
| Example 18 | Li₆PS₅Cl | 5 | 800 | 15 | 1245 | 75 | B |
| Example 19 | Li₇P₃S₁₁ | 5 | 350 | 20 | 24 | 78 | B |
| Example 20 | Li₇P₃S₁₁ | 8 | 350 | 20 | 495 | 76 | B |
| Example 21 | Li₇P₃S₁₁ | 5 | 880 | 15 | 1305 | 72 | B |
| Comparative | Li₆PS₅Cl | 2 | 200 | 10 | 15 | 54 | C |
| Example 6 | | | | | | | |
| Comparative | Li₆PS₅Cl | 10 | 1000 | 20 | 1650 | 55 | C |
| Example 7 | | | | | | | |

From the results in Table 2, it can be seen that all-solid-state batteries of Examples 7 to 9 in which pellets of a sulfide-based solid electrolyte (Li₆PS₅Cl) whose surface ten-point average roughness Rz_{JIS} was in the scope of the present invention were used had improved rate characteristics compared to all-solid-state batteries of Comparative Examples 6 and 7 in which pellets of a sulfide-based solid electrolyte whose surface ten-point average roughness Rz_{JIS} was outside of the scope of the present invention were used. Furthermore, from the results of Examples 10 to 12, for Li₇P₃S₁₁, it was confirmed that, if the surface ten-point average roughness Rz_{JIS} was in the scope of the present invention, the rate characteristics of the all-solid-state battery were improved.

### REFERENCE SIGNS LIST

1 Positive electrode
1A Positive electrode current collector
1B Positive electrode mixture layer
2 Negative electrode
2A Negative electrode current collector
2B Negative electrode mixture layer
3 Solid electrolyte layer
10 All-solid-state battery

1. A solid electrolyte material which has a pair of surfaces facing each other and includes at least one of a halide-based solid electrolyte and a sulfide-based solid electrolyte represented by the following Expression (1):
Li₂₊ₐE_{1-b}G_{b}D_{c}X_{d} (1)
(in Expression (1), E is at least one element selected from the group consisting of Al, Sc, Y, Zr, Hf, and lanthanoids, G is at least one element selected from the group consisting of Na, K, Rb, Cs, Mg, Ca, Sr, Ba, B, Si, Ti, Cu, Nb, Ag, In, Sn, Sb, Ta, W, Au, and Bi, D is at least one group selected from the group consisting of CO₃, SO₄, BO₃, PO₄, NO₃, SiO₃, OH, and O₂, X is at least one selected from the group consisting of F, Cl, Br, and I, and a, b, c, and d are numbers which satisfy 0≤a<1.5, 0≤b<0.5, 0≤c≤5, and 0<d≤6.1 ),
wherein at least one of the pair of surfaces has a surface ten-point average roughness Rz_{JIS} in a range of 20 nm or more and 1500 nm or less.

2. The solid electrolyte material according to claim 1, wherein the solid electrolyte material has an average thickness of 2.0 μm or more.

3. An all-solid-state battery, comprising:
the solid electrolyte material according to claim 1;
a positive electrode mixture layer in contact with one of the pair of surfaces of the solid electrolyte material; and
a negative electrode mixture layer in contact with the other of the pair of surfaces of the solid electrolyte material.

4. An all-solid-state battery, comprising:
the solid electrolyte material according to claim 2;
a positive electrode mixture layer in contact with one of the pair of surfaces of the solid electrolyte material; and
a negative electrode mixture layer in contact with the other of the pair of surfaces of the solid electrolyte material.
